(19) United States
(12) Patent Application Publication
(10) Pub. No.: US 2024/0429945 A1
(43) Pub. Date: Dec. 26, 2024

(54) MODULATION CONTROL APPARATUS, MODULATION CONTROL METHOD, AND COMPUTER READABLE MEDIUM

(71) Applicant: NEC Corporation, Tokyo (JP)

(72) Inventors: Kenji WAKAFUJI, Tokyo (JP); Kohei YOSHIDA, Tokyo (JP)

(73) Assignee: NEC Corporation, Tokyo (JP)

(21) Appl. No.: 18/734,235

(22) Filed: Jun. 5, 2024

(30) Foreign Application Priority Data
Jun. 20, 2023 (JP) 2023-101178

(51) Int. Cl. H04B 1/00

(52) U.S. Cl. CPC H04B 1/0003

(57) ABSTRACT

In one aspect of the present example embodiment, a modulation control apparatus includes at least one memory configured to store an instruction, and at least one processor configured to execute the instruction, wherein the processor, by executing the instruction, acquires data relating to a temperature during a predetermined period, and sets signal point arrangement used for modulation of a transmission signal in such a way that the signal point arrangement used for modulation of the transmission signal is switched to different signal point arrangement during the predetermined period, based on the data relating to the temperature.

### INCORPORATION BY REFERENCE

This application is based upon and claims the benefit of priority from Japanese patent application No. 2023-101178, filed on Jun. 20, 2023, the disclosure of which is incorporated herein in its entirety by reference.

### TECHNICAL FIELD

The present disclosure relates to a modulation control apparatus, a modulation control method, and a program.

### BACKGROUND ART

A technique for improving communication quality has been studied.

For example, Japanese Unexamined Patent Application Publication No. 2017-184096 discloses a satellite communication system including a satellite station and a ground station. The satellite station includes a frequency compensation circuit for pre-compensating a frequency characteristic of each of an up-converter and an amplifier that are provided inside. The ground station includes a coefficient calculation unit that calculates a filter coefficient used in the frequency compensation circuit and a transmission unit that transmits the filter coefficient to the satellite station. Herein, the coefficient calculation unit is capable of selecting a frequency characteristic associated with a temperature of the satellite station and calculating a new filter coefficient by using the frequency characteristic being selected.

A temperature change is caused by executing digital modulation for a transmission signal by a transmitter and transmitting the transmission signal being modulated, and thereby a non-linear characteristic of an amplifier that amplifies the transmission signal is changed in some cases. Further, when the non-linear characteristic of the amplifier is changed, a phenomenon such as gain compression or a memory effect may occur in a transmission signal, leading to a possibility of occurring a bit error in the transmission signal. The technique according to Japanese Unexamined Patent Application Publication No. 2017-184096 is for executing frequency compensation, based on a temperature of a reception side without considering an influence of a temperature of a transmission side on a transmission signal, and hence cannot solve the problem.

### SUMMARY

One example object of the present disclosure is to provide a modulation control apparatus, a modulation control method, and a program that are capable of suppressing a bit error of a transmission signal even when a temperature is changed. Note that, it should be taken into consideration that the object is merely one of a plurality of the objects to be achieved by a plurality of example embodiments disclosed herein. Other objects or problems and novel features are apparent from the description or the accompanying drawings in the present specification.

In a first example aspect of the present example embodiment, a modulation control apparatus includes at least one memory configured to store an instruction, and at least one processor configured to execute the instruction, wherein the processor, by executing the instruction, acquires data relating to a temperature during a predetermined period, and sets signal point arrangement used for modulation of a transmission signal in such a way that the signal point arrangement used for modulation of the transmission signal is switched to different signal point arrangement during the predetermined period, based on the data relating to the temperature.

In a second example aspect of the present example embodiment, a modulation control method is executed by a computer, and includes acquiring data relating to a temperature during a predetermined period, and setting signal point arrangement used for modulation of a transmission signal in such a way that the signal point arrangement used for modulation of the transmission signal is switched to different signal point arrangement during the predetermined period, based on the data relating to the temperature.

In a third example aspect of the present example embodiment, a program causes a computer to execute acquiring data relating to a temperature during a predetermined period, and setting signal point arrangement used for modulation of a transmission signal in such a way that the signal point arrangement used for modulation of the transmission signal is switched to different signal point arrangement during the predetermined period, based on the data relating to the temperature.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram illustrating one example of a modulation control apparatus according to the present disclosure;

FIG. 2 is a flowchart illustrating one example of processing of the modulation control apparatus according to the present disclosure;

FIG. 3 is a schematic diagram illustrating one example of a wireless communication system according to the present disclosure;

FIG. 4 is a block diagram illustrating one example of a base station according to the present disclosure;

FIG. 5 is a graph illustrating an example of non-linear characteristics;

FIG. 6 is a graph illustrating an example of a change of the non-linear characteristics due to a temperature change;

FIG. 7A is a diagram illustrating one example of signal point arrangement according to the present disclosure;

FIG. 7B is a diagram illustrating another example of the signal point arrangement according to the present disclosure;

FIG. 8 is a block diagram illustrating one example of a terminal according to the present disclosure;

FIG. 9A is a flowchart illustrating one example of processing of an information processing apparatus according to the present disclosure;

FIG. 9B is a flowchart illustrating one example of processing of the information processing apparatus according to the present disclosure;

FIG. 9C is a flowchart illustrating one example of processing of the information processing apparatus according to the present disclosure;

FIG. 10 is a flowchart illustrating one example of processing of the terminal according to the present disclosure; and

FIG. 11 is a block diagram illustrating one example of a hardware configuration of an apparatus according to the present disclosure.

### EXAMPLE EMBODIMENT

Hereinafter, with reference to the drawings, example embodiments of the present disclosure are described. Note that, the following description and the drawings in the example embodiments are omitted and simplified as appropriate for clarity of the description. For example, in each of the drawings, the same or associated elements are denoted with the same reference signs, and redundant description is omitted as required for clarity of the description. Further, as a matter of course, the drawings that are referred to for description in each of the example embodiments are applicable to other example embodiments. Furthermore, in this disclosure, when “at least any of” a plurality of items are defined, the definition may refer to any one item or a plurality of any item (including all the items), unless otherwise specified.

Each drawing referred to in the example embodiments is merely an example for describing one or more example embodiments. Each drawing may be associated with one or more other example embodiments instead of being associated with only one specific example embodiment. As understood by a person skilled in the art, various features or steps that are described with reference to any one of the drawings may be combined with features or steps that are illustrated in one or more other drawings in such a way as to create an example embodiment not being explicitly illustrated or described, for example. All the features or the steps that are illustrated in one or more drawings for describing an example embodiment being exemplary are not necessary, and some of the features or the steps may be omitted. An order of the steps described in any of the drawings may be changed as appropriate.

### First Example Embodiment

### [Description of Configuration]

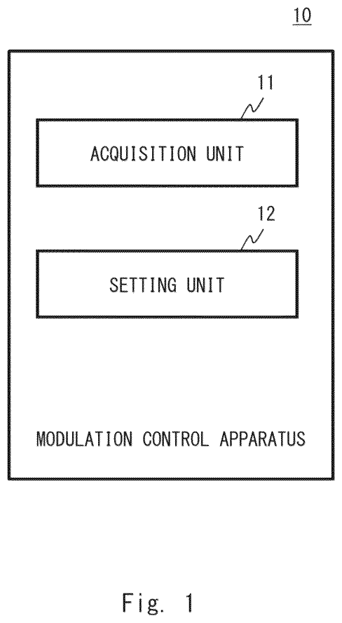

FIG. 1 is a block diagram illustrating one example of a modulation control apparatus. A modulation control apparatus 10 includes an acquisition unit 11 and a setting unit 12. Each unit (each means) of the modulation control apparatus 10 is controlled by a control unit (controller), which is omitted in illustration. The modulation control apparatus 10 may be mounted on a transmitter that transmits a transmission signal being a target to which signal point arrangement is applied, or may be provided as an apparatus independent from the transmitter. Hereinafter, each unit of the modulation control apparatus 10 is described.

The acquisition unit 11 acquires data relating to a temperature during a predetermined period. For example, the predetermined period is a period of time that is future from a data acquisition time point and serves as a target for predicting a temperature change. It is assumed that a length of the period is any length, for example, from one to several hours, from one to several days, from one to several weeks, from one to several months, a year, or the like.

The data relating to the temperature includes data of temperatures in a plurality of sub sections of the predetermined period. For example, the temperature may be an air temperature or a room temperature of an installation location of the transmitter that transmits the transmission signal by applying the signal point arrangement being set by the modulation control apparatus 10. As one example, when the predetermined period is one day, a numerical value indicating an air temperature for each sub section, for example, one minute or ten minutes, may be included in the data relating to the temperature. When the predetermined period is several months, a numerical value indicating an air temperature for each sub section, for example, one day or one week, may be included in the data relating to the temperature. For example, the numerical value indicating the air temperature included in the data relating to the temperature is a temperature being at least any of a maximum air temperature, a minimum air temperature, and an average air temperature for one day or one week.

The modulation control apparatus 10 may acquire the above-described data relating to the temperature from an external apparatus via a network such as the Internet. Alternatively, the modulation control apparatus 10 may include a generation unit that generates the data relating to the temperature. For example, the modulation control apparatus 10 may derive the data relating to the temperature by using an artificial intelligence (AI) model being performed learning in advance. The learning is performed by inputting, to the AI model, training data including information relating weather on a date in the past as a sample and information (a correct answer label) on the data relating to the temperature being associated with the information relating weather. The information relating to weather is information relating to weather being a factor that decides a temperature. For example, the information includes information relating at least any of a sky condition such as sunny and rainy, an air temperature, humidity, an atmospheric pressure, a wind speed, and a wind direction at the installation location of the transmitter to which the signal point arrangement being set by the modulation control apparatus 10 is applied, and a weather map. The information of the data relating to the temperature, which is a correct answer label, is information relating to an air temperature or a room temperature at the installation location of the transmitter.

After the AI model is performed learning by using the training data, the acquisition unit 11 inputs information relating to weather during the predetermined period being a prediction target to the AI model. The AI model outputs the data relating to the temperature during the predetermined period, based on the input information. In this manner, the acquisition unit 11 is capable of acquiring the data relating to the temperature. Note that, the learning of the AI model can use any technique such as logistic regression and a neural network.

However, the modulation control apparatus 10 may use any algorithm in place of the AI model. The modulation control apparatus 10 is capable of acquiring the data relating to the temperature during the predetermined period by inputting, to the algorithm, information relating to weather during the predetermined period being a prediction target.

The setting unit 12 sets signal point arrangement used for modulation of a transmission signal in such a way that the signal point arrangement used for modulation of the transmission signal is switched to different signal point arrangement during the predetermined period, based on the data relating to the temperature being acquired by the acquisition unit 11.

For example, the setting unit 12 may specify timing at which a magnitude relationship between a temperature and a predetermined threshold value is changed during the predetermined period by referring to the data relating to the temperature. In other words, the setting unit 12 may specify at least any of timing at which a state in which a temperature is higher than the predetermined threshold value is shifted to a state in which the temperature is equal to or lower than the predetermined threshold value, and timing at which the state in which the temperature is equal to or lower than the predetermined threshold value is shifted to the state in which the temperature is higher than the predetermined threshold value.

However, the timing being specified by the setting unit 12 is not limited to those described above. In another example, the setting unit 12 may specify timing at which temperature change is equal to or greater than a predetermined threshold value in a certain time period during the predetermined period by referring to the data relating to the temperature. The change of a temperature indicates at least any of rising of the temperature and lowering of the temperature.

Further, the setting unit 12 may use an AI model being performed learning in advance in such a way as to specify timing by using a temperature. The learning is performed by inputting, to the AI model, training data including the data relating to the temperature in the past as a sample and information (a correct answer label) indicating timing at which the signal point arrangement is to be switched being associated with the data relating to the temperature. After the AI model is performed learning by using the training data, the setting unit 12 inputs the data relating to the temperature during the predetermined period being a prediction target to the AI model. The AI model outputs the information indicating the timing at which the signal point arrangement is to be switched during the predetermined period, based on the input information. In this manner, the setting unit 12 is capable of acquiring the information indicating the timing at which the signal point arrangement is to be switched. Note that, the learning of the AI model can use any technique such as logistic regression and a neural network.

Further, in another example, the setting unit 12 may estimate a change of a non-linear characteristic of an amplifier that amplifies a transmission signal, based on the data relating to the temperature, and specify the timing at which the signal point arrangement is to be switched during the predetermined period, based on the estimation result. The setting unit 12 may use an AI model being performed learning in advance in order to specify the timing. The learning is performed by inputting, to the AI model, training data including data indicating a change of a non-linear characteristic in the past as a sample and information (a correct answer label) indicating the timing at which the signal point arrangement is to be switched, which is associated with the data indicating a change. After the AI model is performed learning by using the training data, the setting unit 12 inputs the data indicating a change of the non-linear characteristic during the predetermined period being a prediction target to the AI model. The AI model outputs the information indicating the timing at which the signal point arrangement is to be switched during the predetermined period, based on the input information. In this manner, the setting unit 12 is capable of acquiring the information indicating the timing at which the signal point arrangement is to be switched.

However, the setting unit 12 may use any algorithm in place of the AI model. The setting unit 12 is capable of acquiring the information indicating the timing at which the signal point arrangement is to be switched during the predetermined period by inputting, to the algorithm, the data indicating a change of the non-linear characteristic of the amplifier during the predetermined period.

The setting unit 12 sets signal point arrangement in such a way that the signal point arrangement used for modulation of a transmission signal is switched to different signal point arrangement at timing associated with the timing being specified. Note that, the timing associated with the timing being specified may be the very timing being specified by the setting unit 12, or may be timing different from the timing being specified. For example, the timing associated with the timing being specified may be convenient timing for the transmitter, which executes modulation of a transmission signal and transmits the transmission signal, to change the signal point arrangement. As one example, when the transmitter is a transceiver capable of performing reception as well as transmission, the timing associated with the timing being specified may be timing closest to the timing being specified, among pieces of timing at which the transceiver is capable of changing modulation setting in transmission processing and demodulation setting in reception processing at the same time.

For example, the setting unit 12 may set the signal point arrangement used for modulation of a transmission signal to a first signal point arrangement in a section of the predetermined period, the section being associated with a period during which a temperature is higher than the predetermined threshold value. The setting unit 12 sets the signal point arrangement used for modulation of a transmission signal to a second signal point arrangement in a section of the predetermined period, the section being associated with a period during which a temperature is equal to or lower than the predetermined threshold value. Note that, the section being associated with a period in which a temperature is higher than the predetermined threshold value, or is equal to or lower than the predetermined threshold value is such a section that an end of the section matches with timing associated with the timing being specified by the setting unit 12.

In this state, as compared to the first signal point arrangement, the second signal point arrangement is signal point arrangement in which signal points are arranged in such a way that an interval between the signal points is wider as intensity of a transmission signal is higher. Description on specific examples of the first signal point arrangement and the second signal point arrangement are made in a second example embodiment.

In a case in which a temperature is high, when the first signal point arrangement is used, occurrence of a memory effect in a state in which intensity (in other words, power) of a transmission signal is low can be suppressed. On the other hand, in a case in which a temperature is low, when the second signal point arrangement is used, occurrence of gain compression in a state in which intensity of a transmission signal is high can be suppressed.

Note that, when there are a plurality of pieces of timing to be specified, the setting unit 12 is capable of setting signal point arrangement in such a way that the signal point arrangement used for modulation of a transmission signal is switched to different signal point arrangement at at least some of the plurality of pieces of timings as described above. For example, the setting unit 12 performs setting in such a way that signal point arrangement used for modulation of a transmission signal is switched from the second signal point arrangement to the first signal point arrangement at timing at which a state in which a temperature is equal to or lower than the predetermined threshold value is shifted to a state in which a temperature is higher than the predetermined threshold value during the predetermined period. Further, the setting unit 12 may perform setting in such a way that the signal point arrangement used for modulation of a transmission signal is switched back from the first signal point arrangement to the second signal point arrangement at timing at which the state in which the temperature is higher than the predetermined threshold value is shifted to the state in which the temperature is equal to or lower than the predetermined threshold value.

### [Description of Flow]

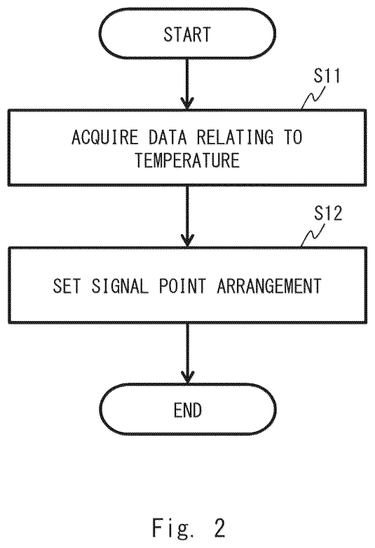

FIG. 2 is a flowchart illustrating one example of representative processing of the modulation control apparatus 10, and description is made on an overview of the processing of the modulation control apparatus 10 with reference to the flowchart. Note that, details of each piece of the processing are as described above, and hence the description therefor is omitted.

First, the acquisition unit 11 acquires data relating to a temperature during a predetermined period (step S11; acquisition step). The setting unit 12 sets signal point arrangement used for modulation of a transmission signal in such a way that the signal point arrangement used for modulation of the transmission signal is switched to different signal point arrangement during the predetermined period, based on the data relating to the temperature (step S12; setting step). The modulation control apparatus 10 may output, to another apparatus, information on the signal point arrangement relating to the predetermined period being set in step S12.

### [Description of Effect]

As indicated above, the setting unit 12 sets signal point arrangement used for modulation of a transmission signal in such a way that the signal point arrangement used for modulation of the transmission signal is switched to different signal point arrangement during a predetermined period, based on data relating to a temperature. With this, even when a non-linear characteristic of the amplifier that amplifies a transmission signal is changed due to a temperature change, the modulation control apparatus 10 is capable of suppressing occurrence of a phenomenon such as gain compression or a memory effect in the transmission signal. Thus, even when a temperature is changed, the modulation control apparatus 10 is capable of suppressing a bit error of a transmission signal.

Further, the setting unit 12 may set signal point arrangement used for modulation of a transmission signal in such a way that the signal point arrangement is switched to different signal point arrangement at timing associated with timing at which a magnitude relationship between a temperature and a predetermined threshold value is changed during the predetermined period. With this, the modulation control apparatus 10 is capable of switching the signal point arrangement at timing at which it is considered that the non-linear characteristic is changed, and hence occurrence of a phenomenon such as gain compression or a memory effect in a transmission signal can be suppressed securely.

Further, during the predetermined period, the setting unit 12 may set signal point arrangement to be used to the first signal point arrangement in a section associated with a period during which a temperature is higher than the predetermined threshold value, and set the signal point arrangement to be used to the second signal point arrangement in a section associated with a period during which a temperature is equal to or lower than the predetermined threshold value. Herein, as compared to the first signal point arrangement, the second signal point arrangement is signal point arrangement in which signal points are arranged in such a way that an interval between the signal points is wider as intensity of a transmission signal is higher. Thus, the modulation control apparatus 10 is capable of suppressing occurrence of a memory effect and gain compression effectively.

### Second Example Embodiment

With reference to the drawings, a second example embodiment is described below in detail. The second example embodiment discloses a specific application example of the modulation control apparatus described in the first example embodiment, but the specific application example of the modulation control apparatus described in the first example embodiment is not limited below. Further, a configuration and processing described below are merely examples, and are not limited thereto. As a matter of course, all or any part of the configuration described in the second example embodiment are suitably applicable to the modulation control apparatus described in the first example embodiment, and the drawings referred to in the second example embodiment are suitably applicable to the first example embodiment.

### [Description of Configuration]

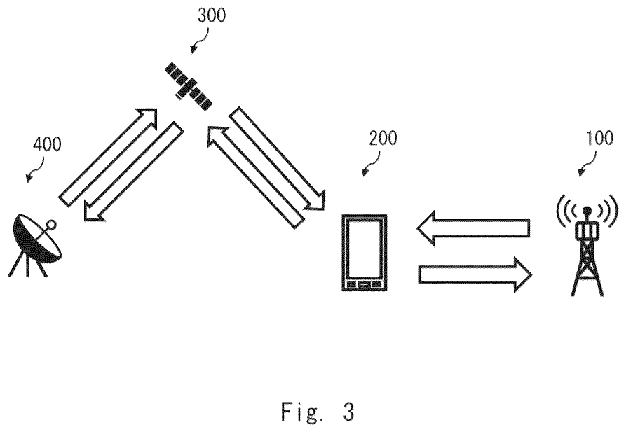

FIG. 3 is a schematic diagram illustrating one example of a wireless communication system. A wireless communication system S includes a base station 100, a terminal 200, an artificial satellite 300, and a reception station 400. Bidirectional wireless communication is mutually executed between the base station 100 and the terminal 200, the terminal 200 and the artificial satellite 300, and the artificial satellite 300 and the reception station 400. The terminal 200 is a moving body, and the wireless communication system S enables mobile communication. Further, the reception station 400 functions as a gateway for connecting a backhaul connected to the reception station 400 and the artificial satellite 300 to each other.

In each wireless communication, a transmitter-side apparatus executes adaptive modulation and coding (ACM) as required and non-linear compensation occurring in an amplifier for a transmission signal. ACM is a technique of switching a modulation scheme and a coding scheme depending on whether a wireless communication line (hereinafter, also simply referred to as a line) is in a satisfactory state or not. By using ACM, a transmitter is capable of changing methods of error correction and multi-valuing in a transmission signal according to a condition of the line. Further, when the transmitter executes non-linear compensation, an effect of multi-valuing can further be improved, and wireless communication capacity can be increased.

However, when the transmitter executes the above-mentioned processing in order to increase communication capacity, the processing requires calculation, and power consumption in the transmitter is increased accordingly. Therefore, in wireless communication, it is desirable to achieve both increased communication capacity and reduced power consumption. In the second example embodiment, description is made on a method for achieving increased communication capacity and reduced power consumption by integrally controlling a plurality of pieces of processing executed inside the transmitter. More specifically, the transmitter is capable of changing various types of processing to be executed and suppressing used power by comprehensively deciding a condition of the line, power supply capacity being available for the processing, a temperature condition at an installation location of the transmitter, and the like. Hereinafter, details of the base station 100 and the terminal 200 are particularly described.

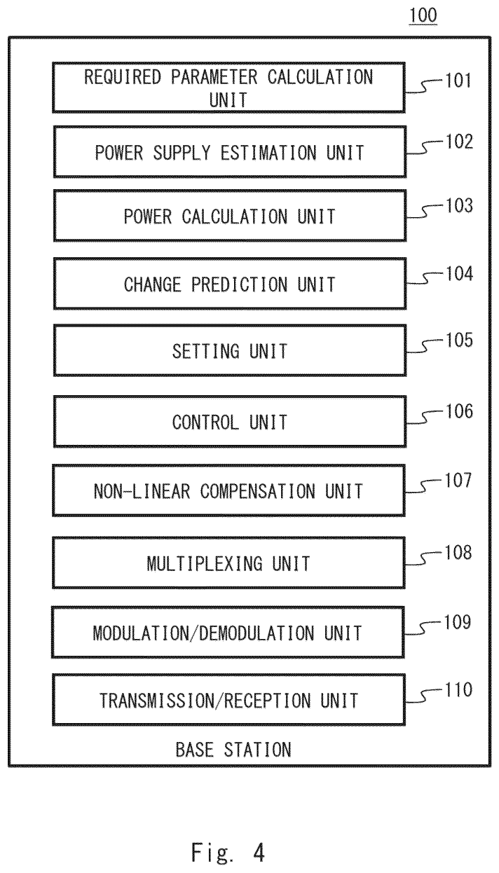

FIG. 4 is a block diagram illustrating one example of the base station 100. The base station 100 includes a required parameter calculation unit 101, a power supply estimation unit 102, a power calculation unit 103, a change prediction unit 104, a setting unit 105, a control unit 106, a non-linear compensation unit 107, a multiplexing unit 108, a modulation/demodulation unit 109, and a transmission/reception unit 110. Hereinafter, description is made while assuming that the base station 100 is a transmitter that transmits a transmission signal to the terminal 200. Note that, the terminal 200 may be, but not limited to, one, and a plurality of terminals may be provided.

The required parameter calculation unit 101 acquires an index value indicating a condition of a line that connects the base station 100 and the terminal 200 to each other, uses the acquired index value, and thereby calculates a required signal-noise ratio (S/N) such that satisfies a parameter indicating accuracy required for a transmission signal. For example, the index value indicating a condition of a line may be channel state information (CSI), but an example of the index value is not limited thereto. Further, the parameter indicating accuracy is a value being set in advance in the base station 100, and is a value indicating that a transmission signal is to be transmitted at or below the error rate. In the present example, a bit error rate (BER) is used as the parameter indicating accuracy, but an example of the parameter to be used is not limited thereto.

The required parameter calculation unit 101 calculates required transmission power by using the required S/N being calculated. The required transmission power indicates power to be allocated to transmission of a transmission signal. Note that, when a numerical value of the required BER is reduced, an allowable noise ratio in the required S/N is reduced. In this case, as compared to a case in which the numerical value of the required BER is high, at least any of a phenomenon where the number of pieces of processing executed by the base station 100 is increased and a phenomenon where a processing time period is elongated occurs. Therefore, when the numerical value of the required BER is reduced, the required transmission power being calculated by the required parameter calculation unit 101 becomes a higher value.

When the required BER is changed, the required parameter calculation unit 101 calculates the required S/N such that satisfies the required BER being changed. Further, the required parameter calculation unit 101 newly calculates the required transmission power by using the required S/N being calculated. In this manner, the required parameter calculation unit 101 is capable of calculating the required transmission power for a plurality of times as required.

The power supply estimation unit 102 estimates power that is supplied to the base station 100 and can be used by the base station 100. The power supply estimation unit 102 may estimate at least any of power supplied from the outside of the base station 100, power supplied, to the base station 100, from a power generation apparatus attached to the base station 100, and both of them as power that can be used by the base station 100. The power supplied from the outside of the base station 100 or the power generation apparatus attached to the base station 100 may be power being constant regardless of time, or power being changed over time. An example of the latter case includes renewable energy-derived power. For example, renewable energy refers to energy derived from at least any of solar light, wind energy, hydro energy, geothermal heat, solar heat, heat present in the atmosphere, heat present in other nature, and biomass.

For example, the power supply estimation unit 102 may derive data relating to power supply by using an AI model being performed learning in advance. The learning is performed by inputting, to the AI model, training data including information relating to power supply on a date in the past as a sample and information (a correct answer label) on a power supply value being associated with the information relating to power supply. The information relating to power supply is information being a factor for deciding the power supply value. For example, when power supply is derived from solar light or solar heat, the information relating to power supply may include information on a sky condition such as sunny and rainy for each sub section (for example, every hour or every day) at the installation location of the base station 100. Further, when power supply is derived from wind energy, the information relating to power supply may include information indicating a wind speed and a wind direction for each sub section at the installation location of the base station 100. The information on a power supply value, which is a correct answer label, is information on the power supply value supplied to the base station 100.

After the AI model is performed learning by using the training data, the power supply estimation unit 102 inputs the information relating to power supply during a predetermined period being a prediction target to the AI model. The AI model outputs data relating to power supply during the predetermined period, based on the input information. Note that, the learning of the AI model can use any technique such as logistic regression and a neural network.

However, the power supply estimation unit 102 may use any algorithm in place of the AI model. The power supply estimation unit 102 is capable of acquiring the data relating to power supply during the predetermined period by inputting, to the algorithm, the information relating to power supply during the predetermined period being a prediction target.

The power calculation unit 103 calculates power (hereinafter, also referred to as usable power) that can be used by the non-linear compensation unit 107 and the multiplexing unit 108 at each piece of timing during the predetermined period by using the data relating to power supply during the predetermined period being estimated by the power supply estimation unit 102. Each piece of timing during the predetermined period is timing at which a unit time for executing processing such as signal point arrangement, non-linear compensation, and multiplexing, or a time enabling switching of such processing is set. For example, the power calculation unit 103 may calculate usable power by subtracting a power value (hereinafter, also referred to as a used power value) used for processing other than signal point arrangement, non-linear compensation, and multiplexing from the power supply value indicated by the data relating to power supply.

The used power value may be a substantially constant value, for example. The power calculation unit 103 is capable of calculating the usable power by subtracting a substantially constant value from the power supply value indicated by the data relating to power supply.

In another example, the used power value may be changed over time. For example, as a reason for the change in the used power value over time, it is conceivable that a communication volume is changed due to a change in the number of terminals 200, or presence or absence of necessity of non-linear compensation for a wireless signal received from the terminal 200 by the base station 100 is changed over time. In such a case, the power calculation unit 103 may derive the used power value during the predetermined period by using an AI model being performed learning in advance. The learning is performed by inputting, to the AI model, training data including information relating to a used power value for each sub section (for example, every hour or every day) in the past as a sample and information (a correct answer label) on a used power value being associated with the information relating to the used power value. The information relating to the used power value is information being a factor for deciding the used power value. For example, the information relating to the used power value may include information relating to a date, information relating to presence or absence of an event in a cell covered by the base station 100, or the like.

After the AI model is performed learning by using the training data, the power calculation unit 103 inputs the information relating to the used power value during the predetermined period being a prediction target to the AI model. The AI model outputs data relating to the used power value during the predetermined period, based on the input information. Note that, the learning of the AI model can use any technique such as logistic regression and a neural network. The power calculation unit 103 is capable of calculating the usable power at each piece of timing by using the used power value being calculated as described above.

However, the power calculation unit 103 may use any algorithm in place of the AI model. The power calculation unit 103 is capable of acquiring the data relating to the used power value during the predetermined period by inputting, to the algorithm, the information relating to the used power value during the predetermined period being a prediction target.

Whether the non-linear compensation unit 107 and the multiplexing unit 108 are capable of executing non-linear compensation and multiplexing, respectively, is changed, depending on a magnitude of the usable power being calculated. In other words, as the usable power is higher, a possibility that both multiplexing and non-linear compensation can be achieved is higher.

Note that, when the required parameter calculation unit 101 newly calculates required transmission power, the power calculation unit 103 calculates the usable power by using the required transmission power being newly calculated as described above. In this manner, the power calculation unit 103 is capable of calculating the usable power for a plurality of times as required.

Further, the power calculation unit 103 is capable of calculating the following power at each piece of timing during the predetermined period, based on signal point arrangement being set by the setting unit 105.
First power required at a time of executing control of signal point arrangement and non-liner compensation according to the signal point arrangement being set
Second power required at a time of executing multiplexing by the multiplexing unit 108
   The first power includes at least power required for the modulation/demodulation unit 109 to set signal point arrangement of a transmission signal to the signal point arrangement being set by the setting unit 105, and power (hereinafter, also referred to as fourth power) required at a time of executing non-linear compensation by the non-linear compensation unit 107. Herein, the first power has a value greater than the fourth power.

Note that, the first power required at a time of executing control of the signal point arrangement and non-linear compensation may be net power required at a time of executing control of the signal point arrangement and non-linear compensation, or may be power acquired by adding power by a predetermined margin to the required net power. Further, the second power required at a time of executing multiplexing may be net power required at a time of executing multiplexing, or may be power acquired by adding power by a predetermined margin to the required net power. Similarly, the fourth power being power required at a time of executing non-linear compensation may be net power required at a time of executing non-linear compensation, or may be power acquired by adding power by a predetermined margin to the required net power. The power calculation unit 103 calculates at least any of the first power, the second power, and the fourth power as described above, and thereby is capable of further suppressing a possibility that power used for processing at a time when the processing is actually executed exceeds the usable power.

The change prediction unit 104 acquires data relating to an air temperature during the predetermined period being a prediction target from outside of the base station 100. The change prediction unit 104 predicts a change of a non-linear characteristic of an amplifier (omitted in illustration) of the base station 100 during the predetermined period by using the data relating to the air temperature. The amplifier of the base station 100 is an apparatus that amplifies a transmission signal. Herein, for example, the change prediction unit 104 may derive the change of the non-linear characteristic of the amplifier during the predetermined period by using an AI model being performed learning in advance. The learning is performed by inputting, to the AI model, training data including data relating to an air temperature in the past as a sample and information (a correct answer label) on the change of the non-linear characteristic of the amplifier being associated with the data relating to the air temperature. After the AI model is performed learning by using the training data, the change prediction unit 104 inputs the data relating to the air temperature during the predetermined period being a prediction target to the AI model. The AI model outputs the information relating to the change of the non-linear characteristic of the amplifier during the predetermined period, based on the input information. Note that, the learning of the AI model can use any technique such as logistic regression and a neural network.

However, the change prediction unit 104 may use any algorithm in place of the AI model. The change prediction unit 104 is capable of acquiring the information relating to the change of the non-linear characteristic of the amplifier during the predetermined period by inputting, to the algorithm, the data relating to the air temperature during the predetermined period being a prediction target.

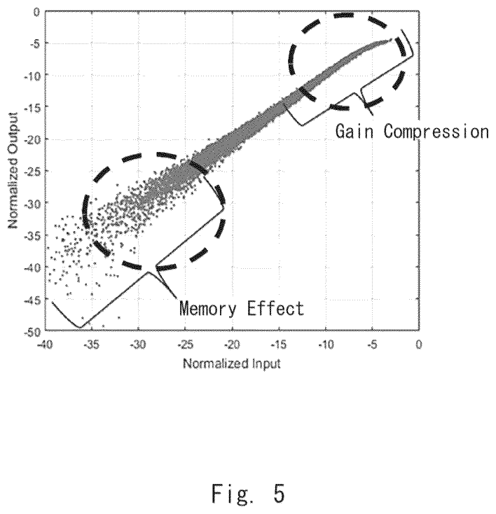

FIG. 5 is a graph illustrating an example of non-linear characteristics at a certain temperature. In the graph in FIG. 5, a horizontal axis indicates normalized input power of a transmission signal being input to the amplifier, and a vertical axis indicates normalized output power of a transmission signal being output from the amplifier. FIG. 5 illustrates that, when the input power is low, variation dispersion due to a memory effect in which a history of a transmission signal being previously input to the amplifier remains in the amplifier occurs. For example, a memory effect occurs when a communication speed is from 1 to 10 GPPS. Further, FIG. 5 also illustrates that, when the input power is high (in particular, when the input power is near a saturation point), gain compression, which refers to difficulty in increasing the output power, occurs. In other words, it is illustrated that, both in a case in which the input power is low and a case in which the input power is high, non-linearity caused by different mechanisms occurs in the output of the amplifier.

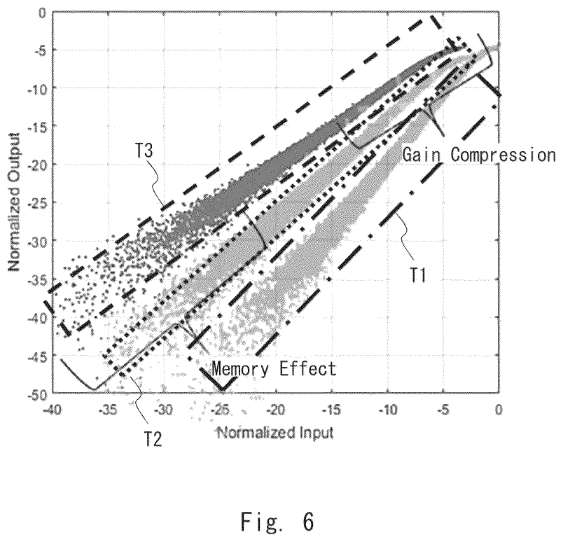

FIG. 6 is a graph illustrating an example of a change of non-linear characteristics due to a temperature change. The horizontal axis and the vertical axis in the graph in FIG. 6 indicate contents similar to the horizontal axis and the vertical axis in the graph in FIG. 5. FIG. 6 indicates non-linear characteristics at each of a temperature T1, a temperature T2, and a temperature T3. Herein, the temperature is higher in an order of T1>T2>T3. In each case of the temperatures T1 to T3, a memory effect clearly appears in the order of the temperatures T1, T2, and T3, and in contrast, gain compression clearly appears in the order of the temperatures T3, T2, and T1. In this manner, the non-linear characteristic of the amplifier is changed according to a temperature change. The change prediction unit 104 recognizes prediction of a temperature change before the base station 100 decides signal point arrangement, and thereby is capable of predicting an influence of the non-linear characteristic on a transmission signal.

The setting unit 105 sets compensation processing considered to be optimal by using an influence of the non-linear characteristic on a transmission signal being predicted by the change prediction unit 104. Specifically, the setting unit 105 refers to the change of the non-linear characteristic being predicted by the change prediction unit 104, and sets signal point arrangement used for modulation of a transmission signal at each piece of timing during the predetermined period from among a plurality of pieces of the signal point arrangement.

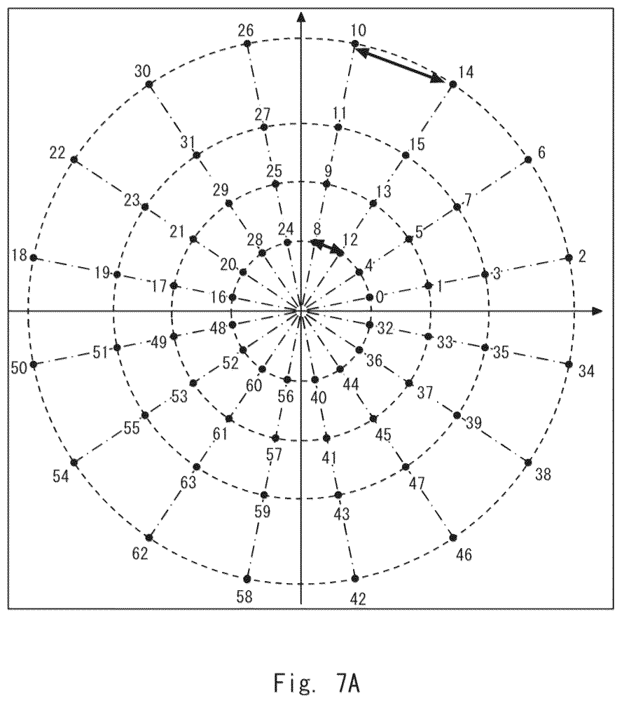

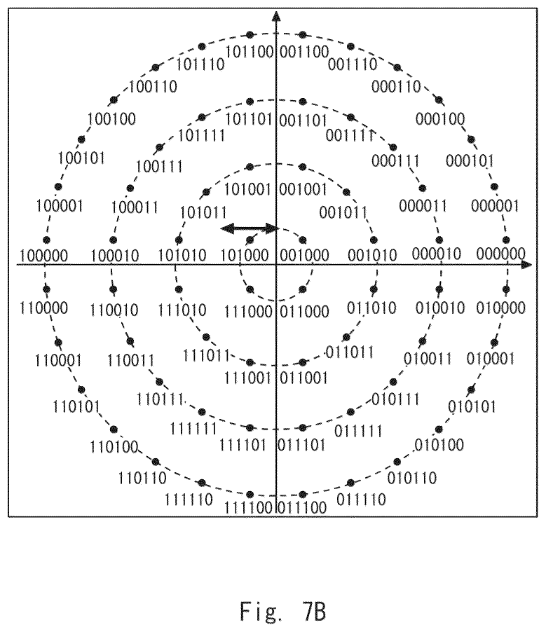

FIGS. 7A and 7B each illustrate an example of signal point arrangement in 64 amplitude and phase-shift keying (APSK). In FIGS. 7A and 7B, the horizontal axes indicate an in-phase component, and the vertical axes indicate a quadrature component. FIG. 7A illustrates the signal point arrangement in which an interval between signal points is wider as power of a transmission signal being an input signal to the amplifier is higher. For example, in FIG. 7A, an interval between “8” and “12” of the signal point arrangement is narrow, but an interval between “10” and “14” of the signal point arrangement is wide. On the other hand, FIG. 7B illustrates the signal point arrangement in which an interval between the signal points is uniform regardless of a magnitude of power of a transmission signal being an input signal. In other words, as compared to the signal point arrangement in FIG. 7B, the signal point arrangement in FIG. 7A is signal point arrangement in which signal points are arranged in such a way that an interval between the signal points is wider as intensity of a transmission signal is higher.

In a case in which the signal point arrangement in FIG. 7A is applied to a transmission signal, when the power of the transmission signal to be input to the amplifier is high, an error in a transmission signal to be output is less likely to occur. Thus, the signal point arrangement in FIG. 7A is suitable for correcting non-linear distortion derived from the amplifier when the power of a transmission signal is high. On the other hand, in a case in which the power of a transmission signal is low, an error in the transmission signal to be output is more likely to occur when the signal point arrangement in FIG. 7A is applied, but an error in the transmission signal to be output is less likely to occur when the signal point arrangement in FIG. 7B is applied. Thus, the signal point arrangement in FIG. 7B is preferably used when the power of a transmission signal is low.

Herein, description is made on preferred signal point arrangement with respect to the non-linear characteristic at each temperature in the graph illustrated in FIG. 6. As described above, at the temperature T1, a memory effect clearly appears, but appearance of gain compression is not eminent. In other words, at the temperature T1, when the power of a transmission signal being an input signal is low, a transmission signal being output from the amplifier is easily degraded. Thus, at the temperature T1, the setting unit 105 selects the signal point arrangement in FIG. 7B where an error in a signal is less likely to occur even when the power of the transmission signal is low.

Meanwhile, at the temperature T3, gain compression clearly appears, but appearance of a memory effect is not eminent. In other words, at the temperature T3, when the power of a transmission signal being an input signal is high, a transmission signal being output from the amplifier is easily degraded. Thus, at the temperature T3, the setting unit 105 selects the signal point arrangement in FIG. 7A where an error in a signal is less likely to occur even when the power of the transmission signal is high.

Note that, at the temperature T2, the setting unit 105 determines which influence, that is, an influence of gain compression in a high power part or an influence of a memory effect in a low power part appears more eminently. Further, the setting unit 105 selects the signal point arrangement in FIG. 7A when gain compression appears eminently, and selects the signal point arrangement in FIG. 7B when a memory effect appears eminently. Note that, when executing the determination described above, the setting unit 105 may acquire an influence degree of each of gain compression and a memory effect on BER characteristic degradation. The BER characteristic degradation is decided based on a required BER being set in advance. The setting unit 105 compares the influence degrees with each other, and specifies one having a higher influence degree of the two. Further, the setting unit 105 specifies whether the part having a higher influence is the higher power part or the lower power part in terms of the non-linear characteristic, and selects the signal point arrangement in FIG. 7A or 7B being less likely to cause an error in the part. Note that, also at the temperatures T1 and T3, the setting unit 105 may execute similar determination, and select appropriate signal point arrangement.

As indicated above, the setting unit 105 is capable of switching signal point arrangement to be set with respect to a transmission signal according to a temperature in an environment in which the amplifier is installed (in other words, an environment in which the base station 100 is installed). Thus, even when a temperature change occurs, the setting unit 105 contributes to suppression of a bit error of a transmission signal. Further, the setting unit 105 can eliminate or suppress non-linear compensation required for a transmission signal.

For example, the setting unit 105 may perform setting in such a way that the signal point arrangement in FIG. 7B is to be used for modulation of a transmission signal in the section associated with a period during which a temperature is higher than a predetermined threshold value, based on a prediction result of the change prediction unit 104. Further, the setting unit 105 may perform setting in such a way that the signal point arrangement in FIG. 7A is to be used for modulation of a transmission signal in the section associated with a period during which a temperature is equal to or lower than the predetermined threshold value, based on a prediction result of the change prediction unit 104.

The setting unit 105 refers to the non-linear characteristic at each piece of timing during the predetermined period, and selects signal point arrangement to be set at each piece of timing by using the above-mentioned method. The setting unit 105 specifies timing at which signal point arrangement is to be switched, based on data relating to the signal point arrangement being selected. Further, the setting unit 105 sets signal point arrangement in such a way that the signal point arrangement used for modulation of a transmission signal is switched to different signal point arrangement at the timing associated with the timing being specified. Herein, “the timing associated with the timing being specified” is timing directly before the timing being specified among pieces of timing at which the base station 100 is capable of changing modulation setting in transmission processing and demodulation setting in reception processing at the same time.

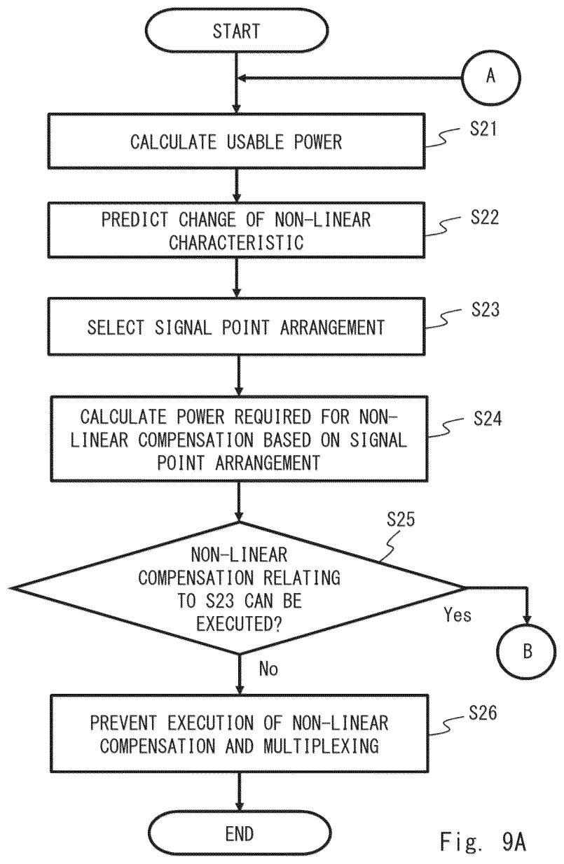

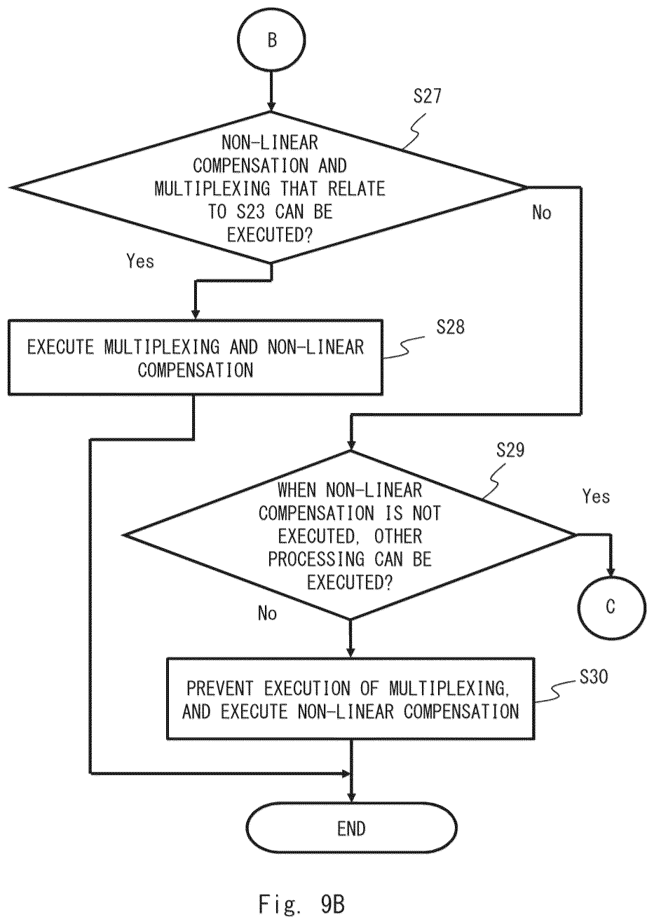

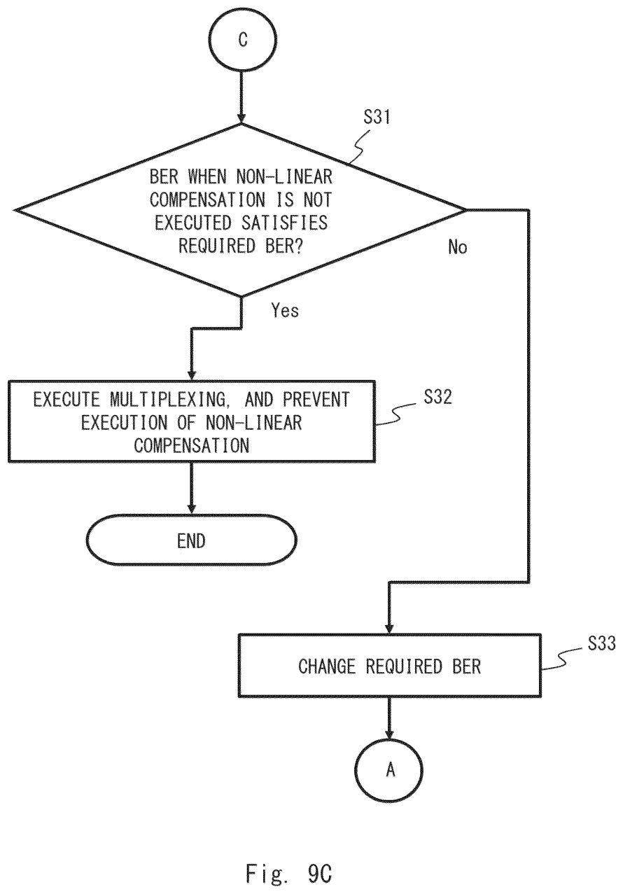

Referring back to FIG. 4, description for the base station 100 is continued. The control unit 106 determines whether at least any of multiplexing or non-linear compensation can be executed with respect to a transmission signal in usable power at each piece of timing, based on data relating to switching of signal point arrangement during the predetermined period being set by the setting unit 105. The control unit 106 performs, based on the signal point arrangement being set by the setting unit 105 in the determination, the above-mentioned determination by using the first power required for executing control the signal point arrangement and non-linear compensation, the second power required at a time of executing multiplexing by the multiplexing unit 108, and the usable power. Further, the control unit 106 decides at least any pieces of processing of multiplexing and non-linear compensation that can be executed with the usable power will be performed. Details of the processing are described in flows illustrated in FIGS. 9A to 9C described below.

When the base station 100 executes multiplexing and non-linear compensation, a calculation amount executed by the base station 100 is increased, and hence power consumption of the base station 100 is increased. In particular, as compared to other processing with respect to a transmission signal, multiplexing and non-linear compensation consume a larger amount of power. Thus, the control unit 106 executes control in such a way as to execute as much pieces of processing as possible with respect to a transmission signal while preventing the power consumption required for the processing from exceeding the usable power, in consideration of the usable power and the power required for each of multiplexing and non-linear compensation.

Note that, when the required parameter calculation unit 101 newly calculates the required transmission power, and the power supply estimation unit 102 newly calculates the usable power, the control unit 106 is capable of executing the above-mentioned determination by using the usable power being changed, the first power, and the second power. In this manner, the control unit 106 is capable of executing the determination for a plurality of times as required.

When the control unit 106 instructs execution of non-linear compensation, the non-linear compensation unit 107 executes non-linear compensation with respect to a transmission signal being output from the amplifier, according to the instruction. When the control unit 106 does not instruct execution of non-linear compensation, the non-linear compensation unit 107 does not execute non-linear compensation with respect to a transmission signal.

When the control unit 106 instructs execution of multiplexing, the multiplexing unit 108 executes multiplexing with respect to a transmission signal being output from the amplifier, according to the instruction. When the control unit 106 does not instruct execution of multiplexing, the multiplexing unit 108 does not execute multiplexing with respect to a transmission signal.

The modulation/demodulation unit 109 executes modulation processing with respect to a transmission signal that is output from the amplifier and is subjected to any of non-linear compensation and multiplexing as required. In the modulation processing, control of the signal point arrangement with respect to a transmission signal is executed based on the signal point arrangement at each piece of timing during the predetermined period being set by the setting unit 105. Further, the modulation/demodulation unit 109 is also capable of executing demodulation processing with respect to a signal being received from the terminal 200 by the transmission/reception unit 110.

The transmission/reception unit 110 transmits a transmission signal being subjected to the modulation processing by the modulation/demodulation unit 109 to the terminal 200. Further, the transmission/reception unit 110 is also capable of receiving a signal from the terminal 200.

Note that, as one example, the required parameter calculation unit 101, the power supply estimation unit 102, the power calculation unit 103, the change prediction unit 104, the setting unit 105, and the control unit 106 may be achieved as functions of a processor as a hardware configuration. The non-linear compensation unit 107, the multiplexing unit 108, the modulation/demodulation unit 109, and the transmission/reception unit 110 may be achieved as a signal processing circuit as a hardware configuration. An example of a case in which the base station 100 is achieved by a hardware configuration is described later.

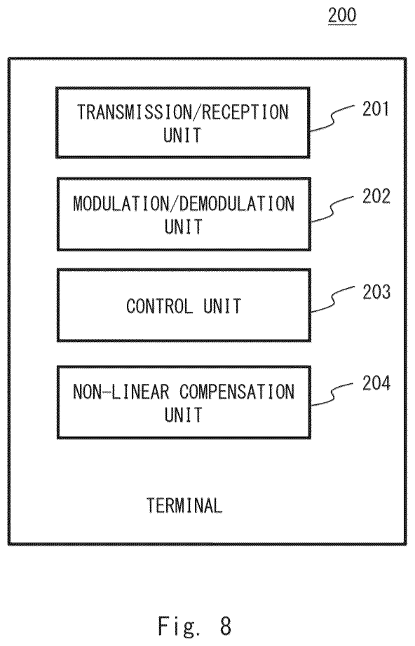

FIG. 8 is a block diagram illustrating one example of the terminal 200. The terminal 200 includes a transmission/reception unit 201, a modulation/demodulation unit 202, a control unit 203, and a non-linear compensation unit 204. Hereinafter, description is made while assuming that the terminal 200 is a receiver that receives a transmission signal from the base station 100.

The transmission/reception unit 201 receives a transmission signal being transmitted from the transmission/reception unit 110 of the base station 100. Further, the transmission/reception unit 201 is also capable of transmitting a signal to the base station 100.

The modulation/demodulation unit 202 executes demodulation processing with respect to a signal being received by the transmission/reception unit 201. Further, the modulation/demodulation unit 202 is also capable of executing modulation processing with respect to a signal that is output from an amplifier of the terminal 200 and is transmitted to the base station 100. In the modulation processing, control of signal point arrangement with respect to a transmission signal may be executed based on signal point arrangement at each piece of timing during the predetermined period being set by the terminal 200.

The control unit 203 determines whether a reception signal being subjected to the demodulation processing by the modulation/demodulation unit 202 is subjected to non-linear compensation in the base station 100. For example, the control unit 203 may perform the determination by detecting a BER of a signal being a determination target and determining whether the BER being detected is equal to or less than the required BER.

When the control unit 203 determines that the reception signal is not subjected to non-linear compensation, the non-linear compensation unit 204 executes non-linear compensation with respect to the reception signal. When the processing is executed, the terminal 200 is capable of acquiring accurate data relating to the reception signal.

### [Description of Flow]

FIGS. 9A to 9C are flowcharts each illustrating one example of representative processing of the base station 100, and description is made on an overview of the processing of the base station 100 with reference to the flowcharts. In the following description, the details of the processing that are described above are omitted as appropriate.

First, the required parameter calculation unit 101 calculates a required S/N by using a required BER. Further, the required parameter calculation unit 101 calculates required transmission power by using the required S/N being calculated. Subsequently, the power supply estimation unit 102 estimates power that is supplied to the base station 100 and can be used by the base station 100. The power calculation unit 103 calculates usable power at each piece of timing during a predetermined period by using data relating to power supply during the predetermined period being estimated by the power supply estimation unit 102 (step S21; usable power calculation step).

The change prediction unit 104 predicts a change of a non-linear characteristic of the amplifier of the base station 100 during the predetermined period by using data relating to an air temperature during the predetermined period being a prediction target (step S22; non-linear characteristic change prediction step).

The setting unit 105 selects signal point arrangement used for modulation of a transmission signal at each piece of timing during the predetermined period from among a plurality of pieces of the signal point arrangement by using an influence of the non-linear characteristic on the transmission signal being predicted by the change prediction unit 104 (step S23; signal point arrangement selection step).

The power calculation unit 103 calculates the first power required at a time of executing control of the signal point arrangement and non-linear compensation and the second power required at a time of executing multiplexing by the multiplexing unit 108 at each piece of timing during the predetermined period, based on the signal point arrangement being set in step S23 (step S24; used power calculation step).

Note that, the processing in at least any of steps S22 to S24 may be executed before the processing in step S21, or may be executed simultaneously with the processing in step S21.

The control unit 106 determines a magnitude relationship between the first power being calculated in step S24 and the usable power (step S25; non-linear compensation determination step). More specifically, the control unit 106 determines whether the first power is equal to or lower than the usable power at all pieces of the timing during the predetermined period. With this, the control unit 106 determines whether non-linear compensation based on the signal point arrangement being set in step S23 can be executed.

When the first power is higher than the usable power at any timing during the predetermined period (No in step S25), the control unit 106 determines that non-linear compensation based on the signal point arrangement being set in step S23 cannot be executed. Further, the control unit 106 also determines that there is no necessity of executing multiplexing with respect to the transmission signal not being subjected to non-linear compensation. Therefore, the control unit 106 executes control in such a way that the non-linear compensation unit 107 does not execute non-linear compensation and the multiplexing unit 108 does not execute multiplexing (step S26; processing decision step). In this case, control of the signal point arrangement being set in step S23 is not executed with respect to the transmission signal. Further, non-linear compensation with respect to the transmission signal is executed by the terminal 200 that receives the transmission signal.

On the other hand, when the first power is equal to or lower than the usable power at all pieces of the timing (Yes in step S25), the control unit 106 derives third power by adding the second power being calculated in step S24 to the first power. Further, the control unit 106 determines whether the third power is equal to or lower than the usable power (step S27; multiplexing determination step). More specifically, the control unit 106 determines whether the third power is equal to or lower than the usable power at all pieces of the timing during the predetermined period. With this, the control unit 106 determines whether non-linear compensation and multiplexing based on the signal point arrangement being set in step S23 can be executed.

When the third power is equal to or lower than the usable power at all pieces of the timing (Yes in step S27), the control unit 106 determines that non-linear compensation and multiplexing based on the signal point arrangement being set in step S23 can be executed. Therefore, the control unit 106 executes control in such a way that the non-linear compensation unit 107 executes non-linear compensation and the multiplexing unit 108 executes multiplexing (step S28; processing decision step). In this case, the signal point arrangement being set in step S23 is executed with respect to the transmission signal. Further, the terminal 200 is not required to execute non-linear compensation with respect to the transmission signal being received.

On the other hand, when the third power is higher than the usable power at any timing during the predetermined period (No in step S27), the power calculation unit 103 calculates the fourth power being power required at a time of executing non-linear compensation. Further, the control unit 106 determines whether fifth power is equal to or lower than the usable power, the fifth power being acquired by subtracting the fourth power from the third power (step S29). More specifically, the control unit 106 determines whether the fifth power is equal to or lower than the usable power at all pieces of the timing during the predetermined period. With this, when non-linear compensation is not executed, the control unit 106 determines whether control of the signal point arrangement being set in step S23 and multiplexing can be executed.

When the fifth power is higher than the usable power at any timing during the predetermined period (No in step S29), the control unit 106 determines that multiplexing cannot be executed, but still non-linear compensation based on the signal point arrangement being set in step S23 can be executed. Therefore, the control unit 106 executes control in such a way that the multiplexing unit 108 does not execute multiplexing, and also executes control in such a way that the non-linear compensation unit 107 executes non-linear compensation (step S30; processing decision step). In this case, the signal point arrangement being set in step S23 is executed with respect to the transmission signal. Further, the terminal 200 is not required to execute non-linear compensation with respect to the transmission signal being received.

When the fifth power is equal to or lower than the usable power at all pieces of the timing (Yes in step S29), the control unit 106 determines whether a BER of the transmission signal satisfies the required BER when setting of the signal point arrangement and multiplexing are executed but non-linear compensation is not executed (step S31; BER determination step). In other words, the control unit 106 determines whether the BER of the transmission signal is equal to or less than the required BER. When non-linear compensation is not executed, there is a possibility that the transmission signal does not satisfy desired quality, and hence the control unit 106 executes the determination.

When the BER of the transmission signal satisfies the required BER (Yes in step S31), the control unit 106 executes control in such a way that the multiplexing unit 108 executes multiplexing, and also executes control in such a way that the non-linear compensation unit 107 does not execute non-linear compensation (step S32; processing decision step). In this case, the signal point arrangement being set in step S23 is executed with respect to the transmission signal. Further, non-linear compensation with respect to the transmission signal is executed by the terminal 200 that receives the transmission signal.

When the BER of the transmission signal does not satisfy the required BER (No in step S31), the control unit 106 changes the required BER in such a way that the BER of the transmission signal in step S31 becomes equal to or less than the required BER (step S33; required BER change step). Further, as indicated in the description on step S21, the required parameter calculation unit 101 calculates the required transmission power by using the required BER being changed. The power supply estimation unit 102 calculates the usable power by using the required transmission power being newly calculated (step S21). Hereinafter, the base station 100 executes the processing after step S22 again by using the required BER being changed and the usable power being newly calculated. Note that, when the processing after step S22 is executed again, the processing in at least one of steps S22 to S24 may be omitted in execution. This is because values being calculated in the steps in a first loop of a flow can be reused in a second loop of the flow.

The base station 100 executes the loop of the flow in FIGS. 9A to 9C until there becomes a state in which the processing that can be executed within the usable power is completely executed while the BER of the transmission signal satisfies the required BER. Further, when such a state is achieved, the base station 100 terminates the loop, and decides the processing to be executed.

Note that, the non-linear compensation unit 107 and the multiplexing unit 108 each execute the processing, based on the control being decided by the control unit 106 in steps S26, S28, S30, and S32. The modulation/demodulation unit 109 modulates the transmission signal being subjected to the processing, and the transmission/reception unit 110 transmits the transmission signal being modulated to the terminal 200.

Note that, in step S25, the control unit 106 may determine whether the first power is equal to or lower than the usable power during a section of the predetermined period, the section being a period equal to or exceeding a certain percentage of the predetermined period or a period equal to or exceeding a predetermined length. Further, also in step S27 or S29, the control unit 106 may also determine whether the third power or the fifth power is equal to or lower than the usable power during a section of the predetermined period, the section being a period equal to or exceeding a certain percentage of the predetermined period or a period equal to or exceeding a predetermined length. With this, the base station 100 is also capable of executing the flow illustrated in FIGS. 9A to 9C.

Further, in step S29, the control unit 106 may set, as the fourth power, power used for a part of non-linear compensation, which is executed by the terminal 200, of the entire non-linear compensation to be executed with respect to a transmission signal. In this case, when the non-linear compensation is not partially executed as a result of the determination in step S29, the control unit 106 determines whether setting of the signal point arrangement relating to step S23 and multiplexing can be executed. When it is determined as No in the determination in step S29, the control unit 106 executes control in such a way that the multiplexing unit 108 does not execute multiplexing, and also executes control in such a way that the non-linear compensation unit 107 executes non-linear compensation (step S30).

On the other hand, when it is determined as Yes in the determination in step S29, the control unit 106 executes the determination in step S31. When the BER of the transmission signal satisfies the required BER (Yes in step S31), the control unit 106 executes control in such a way that the multiplexing unit 108 executes multiplexing. Further, the control unit 106 executes control in such a way that the non-linear compensation unit 107 does not execute a part of the non-linear compensation processing but executes the remaining pieces of the non-linear compensation processing (step S32; processing decision step). In this case, the piece of the non-linear compensation processing not being executed with respect to the transmission signal in step S32 is executed by the terminal 200 that receives the transmission signal.

When the BER of the transmission signal does not satisfy the required BER (No in step S31), the control unit 106 executes the processing after step S33. The details thereof are as described above.

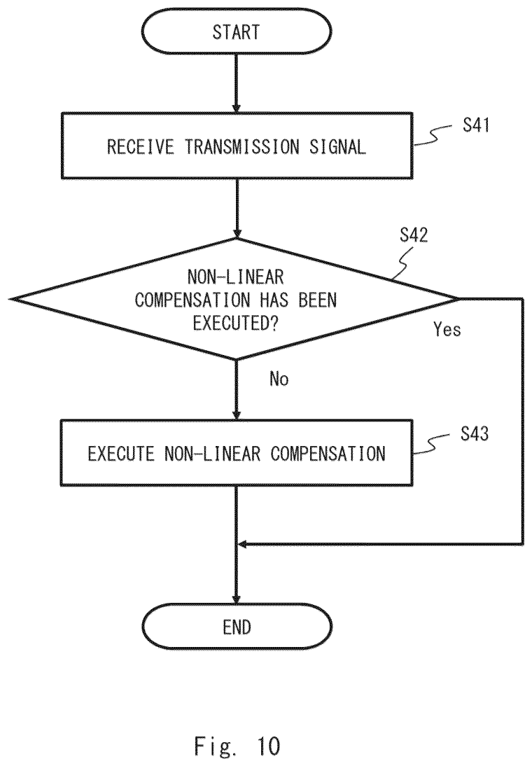

FIG. 10 is a flowchart illustrating one example of representative processing of the terminal 200, and description is made on an overview of the processing of the terminal 200 with reference to the flowchart. In the following description, the details of the processing that are described above are omitted as appropriate.

First, the transmission/reception unit 201 receives a transmission signal being transmitted from the transmission/reception unit 110 of the base station 100 (step S41; reception step). The modulation/demodulation unit 202 executes the demodulation processing with respect to a signal being received by the transmission/reception unit 201.

The control unit 203 determines whether the reception signal being subjected to the demodulation processing by the modulation/demodulation unit 202 has been subjected to non-linear compensation in the base station 100 (step S42; determination step). When the control unit 203 determines that the reception signal has been subjected to non-linear compensation (Yes in step S42), the non-linear compensation unit 204 does not execute non-linear compensation with respect to the reception signal. On the other hand, when the control unit 203 determines that the reception signal has not been subjected to non-linear compensation (No in step S42), the non-linear compensation unit 204 executes non-linear compensation with respect to the reception signal (step S43; non-linear compensation step).

### [Description of Effects]

In the second example embodiment, the change prediction unit 104 of the base station 100 sets signal point arrangement used for modulation of a transmission signal in such a way that the signal point arrangement used for modulation of the transmission signal is switched to different signal point arrangement during a predetermined period, based on data relating to an air temperature during the predetermined period. With this, even when a temperature is changed, the base station 100 is capable of suppressing a bit error of the transmission signal. The details of the reason therefor are as described in the first example embodiment.

Further, the change prediction unit 104 may predict a change of a non-linear characteristic of the amplifier during the predetermined period, based on data relating to a temperature during the predetermined period. The setting unit 105 sets signal point arrangement used for modulation of a transmission signal in such a way that the signal point arrangement used for modulation of the transmission signal is switched to different signal point arrangement during the predetermined period, based on the change of the non-linear characteristic. With this, the base station 100 is capable of changing the signal point arrangement at timing at which the change of the non-linear characteristic of the amplifier occurs and at which a different method of non-linear compensation is considered to be applied. Therefore, a bit error of a transmission signal can be suppressed securely.

Further, the control unit 106 is capable of deciding whether at least any of non-linear compensation and multiplexing is executed by using the first power required at a time of executing control of the signal point arrangement being set and non-linear compensation based on the signal point arrangement, the second power required for multiplexing to be executed with respect to the transmission signal, and the usable power. Therefore, the base station 100 is capable of achieving both suppression of power consumption and at least any of accommodation of increased communication capacity and suppression of a bit error.

Further, when the first power is equal to or lower than the usable power, the third power is higher than the usable power, and the fifth power is higher than the usable power, the control unit 106 executes non-linear compensation based on the signal point arrangement being set, but may decide not to execute multiplexing. With this, the base station 100 is capable of suppressing a bit error of a transmission signal by executing non-linear compensation, and is also capable of suppressing power consumption.

Further, when the first power is equal to or lower than the usable power, the third power is higher than the usable power, the fifth power is equal to or lower than the usable power, and a BER of a transmission signal satisfies the required BER, the control unit 106 may decide to execute multiplexing and not to execute at least part of the non-linear compensation processing. With this, the base station 100 is capable of suppressing power consumption while executing multiplexing that enables increased communication capacity of the transmission signal.

Further, when the first power is equal to or lower than the usable power, the third power is higher than the usable power, the fifth power is equal to or lower than the usable power, and the BER of a transmission signal does not satisfy the required BER, the control unit 106 may change the required BER, and execute the flow again from step S21. With this, the base station 100 changes the required BER only when necessary, and hence the BER of the transmission signal can be maintained at the highest possible level. Further, the base station 100 is capable of executing any executable one of non-linear compensation and multiplexing in a state in which power consumption is suppressed, and hence is capable of achieving accommodation of increased communication capacity in addition to suppression of a bit error.

Note that, the present disclosure is not limited to the above-mentioned example embodiments, and may be changed as appropriate without departing from the gist.

For example, in the second example embodiment, the base station 100 is capable of executing mobile communication with the terminal 200 being a moving body that can move relatively with respect to the base station 100. However, the terminal 200 may be a terminal other than a moving body. In this case, the base station 100 executes fixed communication with the terminal 200. Further, the method described in each of the example embodiments is also applicable to wired communication, as well as wireless communication.

The signal point arrangement being set by the setting unit 105 at each piece of timing during the predetermined period is not limited to those illustrated in FIGS. 7A and 7B. Further, the setting unit 105 may select one piece of signal point arrangement to be applied to a transmission signal from among three or more pieces of the signal point arrangement by the same method as the method described in the second example embodiment.

For example, it is assumed that, as candidates of the signal point arrangement, three pieces of signal point arrangement H1, H2, and H3 are given. As compared to the signal point arrangement H3, the signal point arrangement H1 and H2 are signal point arrangement in which signal points are arranged in such a way that an interval between the signal points is wider as intensity of a transmission signal is higher. The signal point arrangement H3 is signal point arrangement in which signal points are arranged in such a way that an interval between the signal points is uniform. Further, as compared to the signal point arrangement H2, the signal point arrangement H1 is signal point arrangement in which signal points are arranged in such a way that an interval between the signal points is further wider as intensity of a transmission signal is higher. In this case, for example, the setting unit 105 is capable of selecting the signal point arrangement H3 with respect to the non-linear characteristic at the temperature T1 in FIG. 6, selecting the signal point arrangement H2 with respect to the non-linear characteristic at the temperature T2, and selecting the signal point arrangement H1 with respect to the non-linear characteristic at the temperature T3.

In the second example embodiment, the change prediction unit 104 is not required to predict a change of the non-linear characteristic of the amplifier. In this case, by comparing the data relating to the air temperature and the predetermined threshold value with each other or specifying the timing at which temperature change is equal to or greater than a predetermined threshold value in a sub section during the predetermined period, the setting unit 105 may decide the timing at which the signal point arrangement is changed. Further, by using an AI model being learned, the setting unit 105 may decide the timing at which the signal point arrangement is changed. The details of the processing are as described in the examples in the first example embodiment.

In the second example embodiment, the terminal 200 may executes processing similar to that executed by the base station 100 described in the second example embodiment. In this case, the base station 100 executes processing similar to that executed by the terminal 200 described in the second example embodiment. Further, the base station 100 and the terminal 200 may be capable of performing wireless communication in both directions of up-link and down-link, and both the base station 100 and the terminal 200 may execute processing relating to a transmission signal and processing relating to a reception signal that are described in the second example embodiment.

Further, at least any of the artificial satellite 300 and the reception station 400 in FIG. 3 may execute at least any of the processing relating to the transmission signal and the processing relating to the reception signal according to the second example embodiment, in place of the base station 100 and the terminal 200.

The present disclosure is described as a hardware configuration in the example embodiments described above, and the present disclosure is not limited thereto. In the present disclosure, the processing or the steps that are executed by at least any of the apparatuses including the information processing apparatus, the base station, the terminal, the artificial satellite, and the reception station that are described in the above-mentioned example embodiments may be achieved by causing a processor in a computer to execute a computer program.

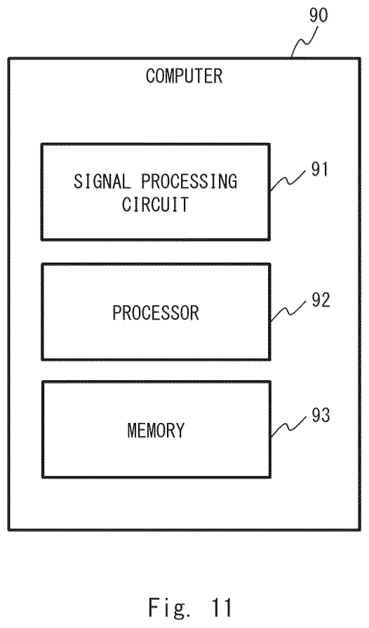

FIG. 11 is a block diagram illustrating a hardware configuration example of an information processing apparatus executing the processing of the apparatus in each of the example embodiments described above. With reference to FIG. 11, an information processing apparatus 90 includes a signal processing circuit 91, a processor 92, and a memory 93.

The signal processing circuit 91 is a circuit for processing a signal in response to control of the processor 92. Note that, the signal processing circuit 91 may include a communication circuit that receives a signal from a transmission apparatus.

The processor 92 is connected or coupled to the memory 93, and executes the processing of the apparatus described in the above-mentioned example embodiments by reading out and executing software or a computer program from the memory 93. Examples of the processor 92 include a central processing unit (CPU), a micro processing unit (MPU), a field-programmable gate array (FPGA), a digital signal processor (DSP), and an application specific integrated circuit (ASIC). As the processor 92, one processor may be used, or a plurality of processors may be used in collaboration.

The memory 93 is configured by a volatile memory, a non-volatile memory, or a combination thereof. Note that, for example, the volatile memory may be a random access memory (RAM) such as a dynamic random access memory (DRAM) and a static random access memory (SRAM). For example, the non-volatile memory may be a read only memory (ROM) such as a programmable read only memory (PROM) and an erasable programmable read only memory (EPROM), a flash memory, and a solid state drive (SSD). As the memory 93, one memory may be used, or a plurality of memories may be used in collaboration.

The memory 93 is used to store one or more commands. Herein, the one or more commands are stored as a software module group in the memory 93. The processor 92 is capable of executing the processing described in the above-mentioned example embodiments by reading out and executing the software module group from the memory 93.

Note that, the memory 93 may include one being embedded in the processor 92, in addition to one being provided outside of the processor 92. Further, the memory 93 may include a storage being arranged away from a processor configuring the processor 92. In this case, the processor 92 is capable of accessing the memory 93 via an input/output (I/O) interface.

As described above, one or a plurality of processors included in each of the apparatuses described in the above-mentioned example embodiments execute one or a plurality of programs including a command group for causing the computer to execute the algorithm described with reference to the drawings. The information processing described in each of the example embodiments can be achieved by executing the processing.

The program includes a command group (or a software code) for causing a computer to execute the one or more functions described in the example embodiments when the program is read by the computer. The program may be stored in a non-transitory computer readable medium or a tangible storage medium. By way of example, and not limitation, the computer readable media or tangible storage media can include a random-access memory (RAM), a read-only memory (ROM), a flash memory, a solid-state drive (SSD) or other memory technologies, compact disk-read only memory (CD-ROM), compact disk-read/write (CD-R/W), digital versatile disk (DVD), Blu-ray Disc® or other optical disk storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

The whole or part of the example embodiments disclosed above can be described as, but not limited to, the following supplementary notes.

### (Supplementary Note 1)

A modulation control apparatus including:
an acquisition means for acquiring data relating to a temperature during a predetermined period; and
a setting means for setting signal point arrangement used for modulation of a transmission signal in such a way that the signal point arrangement used for modulation of the transmission signal is switched to different signal point arrangement during the predetermined period, based on the data relating to the temperature.

### (Supplementary Note 2)

The modulation control apparatus according to supplementary note 1, wherein the setting means sets signal point arrangement used for modulation of the transmission signal in such a way that the signal point arrangement is switched to different signal point arrangement at timing associated with timing at which a magnitude relationship between the temperature and a predetermined threshold value is changed during the predetermined period.

### (Supplementary Note 3)

The modulation control apparatus according to supplementary note 2, wherein
the setting means sets signal point arrangement used for modulation of the transmission signal to first signal point arrangement in a first section of the predetermined period, the first section being associated with a period during which the temperature is higher than the predetermined threshold value, and sets signal point arrangement used for modulation of the transmission signal to second signal point arrangement in a second section of the predetermined period, the second section being associated with a period during which the temperature is equal to or lower than the predetermined threshold value, and,
as compared to the first signal point arrangement, the second signal point arrangement is signal point arrangement in which signal points are arranged in such a way that an interval between signal points is wider as intensity of the transmission signal is higher.

### (Supplementary Note 4)

The modulation control apparatus according to any one of supplementary notes 1 to 3, further including a prediction means for predicting a change of a non-linear characteristic of an amplifier during the predetermined period, based on data relating to a temperature during the predetermined period,
wherein the setting means sets signal point arrangement used for modulation of the transmission signal in such a way that the signal point arrangement used for modulation of the transmission signal is switched to different signal point arrangement during the predetermined period, based on the change of the non-linear characteristic.

### (Supplementary Note 5)

The modulation control apparatus according to any one of supplementary notes 1 to 4, further including a control means for deciding whether to execute at least any of non-linear compensation or multiplexing based on the signal point arrangement being set by the setting means, by using first power being required at a time of executing control of the signal point arrangement being set by the setting means and non-linear compensation according to the signal point arrangement being set, second power being required for executing multiplexing with respect to the transmission signal, and usable power.

### (Supplementary Note 6)

The modulation control apparatus according to supplementary note 5, wherein the control means, when the first power is equal to or lower than the usable power, third power acquired by adding the second power to the first power is higher than the usable power, and fifth power acquired by subtracting fourth power from the third power is higher than the usable power, the fourth power being required for at least part of processing of non-linear compensation processing executed with respect to the transmission signal, decides to execute non-linear compensation based on the signal point arrangement being set by the setting means and not to execute the multiplexing.

### (Supplementary Note 7)

The modulation control apparatus according to supplementary note 5 or 6, wherein the control means, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal satisfies a predetermined condition, decides to execute non-linear compensation and the multiplexing based on the signal point arrangement being set by the setting means in a state in which the at least part of processing is not executed.

### (Supplementary Note 8)

The modulation control apparatus according to any one of supplementary notes 5 to 7, wherein the control means, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal does not satisfy a predetermined condition, changes the predetermined condition, changes the usable power in such a way as to satisfy the predetermined condition being changed, and further decides whether to execute at least any of non-linear compensation or multiplexing based on the signal point arrangement being set by the setting means by using the first power, the second power, and the usable power being changed.

### (Supplementary Note 9)

A communication system including:
a transmitter; and
a receiver, wherein
the transmitter includes
   an acquisition means for acquiring data relating to a temperature during a predetermined period,
   a setting means for setting signal point arrangement used for modulation of a transmission signal in such a way that the signal point arrangement used for modulation of the transmission signal is switched to different signal point arrangement during the predetermined period, based on the data relating to the temperature, and
   a transmission means for transmitting, to the receiver, the transmission signal being modulated by using the signal point arrangement being set by the setting means, and
the receiver includes
   a reception means for receiving the transmission signal from the transmitter, and
   a demodulation means for demodulating the transmission signal being received by the reception means.

### (Supplementary Note 10)

The communication system according to supplementary note 9, wherein the setting means sets signal point arrangement used for modulation of the transmission signal in such a way that the signal point arrangement is switched to different signal point arrangement at timing associated with timing at which a magnitude relationship between the temperature and a predetermined threshold value is changed during the predetermined period.

### (Supplementary Note 11)

The communication system according to supplementary note 10, wherein
the setting means sets signal point arrangement used for modulation of the transmission signal to first signal point arrangement in a first section of the predetermined period, the first section being associated with a period during which the temperature is higher than the predetermined threshold value, and sets signal point arrangement used for modulation of the transmission signal to second signal point arrangement in a second section of the predetermined period, the second section being associated with a period during which the temperature is equal to or lower than the predetermined threshold value, and,
as compared to the first signal point arrangement, the second signal point arrangement is signal point arrangement in which signal points are arranged in such a way that an interval between signal points is wider as intensity of the transmission signal is higher.

### (Supplementary Note 12)

The communication system according to any one of supplementary notes 9 to 11, wherein
the transmitter further includes a prediction means for predicting a change of a non-linear characteristic of an amplifier during the predetermined period, based on data relating to a temperature during the predetermined period, and
the setting means sets signal point arrangement used for modulation of the transmission signal in such a way that the signal point arrangement used for modulation of the transmission signal is switched to different signal point arrangement during the predetermined period, based on the change of the non-linear characteristic.

### (Supplementary Note 13)

The communication system according to any one of supplementary notes 9 to 12, wherein the transmitter further includes a control means for deciding whether to execute at least any of non-linear compensation or multiplexing based on the signal point arrangement being set by the setting means, by using first power being required at a time of executing control of the signal point arrangement being set by the setting means and non-linear compensation according to the signal point arrangement being set, second power being required for executing multiplexing with respect to the transmission signal, and usable power.

### (Supplementary Note 14)

The communication system according to supplementary note 13, wherein the control means, when the first power is equal to or lower than the usable power, third power acquired by adding the second power to the first power is higher than the usable power, and fifth power acquired by subtracting fourth power from the third power is higher than the usable power, the fourth power being required for at least part of processing of non-linear compensation processing executed with respect to the transmission signal, decides to execute non-linear compensation based on the signal point arrangement being set by the setting means and not to execute the multiplexing.

### (Supplementary Note 15)

The communication system according to supplementary note 13 or 14, wherein
the control means, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal satisfies a predetermined condition, decides to execute non-linear compensation and the multiplexing based on the signal point arrangement being set by the setting means in a state in which the at least part of processing is not executed, and
the receiver includes a non-linear compensation means for executing non-linear compensation processing being the at least part of processing with respect to the transmission signal being received by the reception means.

### (Supplementary Note 16)

The communication system according to any one of supplementary notes 13 to 15, wherein the control means, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal does not satisfy a predetermined condition, changes the predetermined condition, changes the usable power in such a way as to satisfy the predetermined condition being changed, and further decides whether to execute at least any of non-linear compensation or multiplexing based on the signal point arrangement being set by the setting means by using the first power, the second power, and the usable power being changed.

### (Supplementary Note 17)

A modulation control method including,
by a computer:
   acquiring data relating to a temperature during a predetermined period; and
   setting signal point arrangement used for modulation of a transmission signal in such a way that the signal point arrangement used for modulation of the transmission signal is switched to different signal point arrangement during the predetermined period, based on the data relating to the temperature.

### (Supplementary Note 18)

The modulation control method according to supplementary note 17, further including, by the computer, setting the signal point arrangement used for modulation of the transmission signal in such a way that the signal point arrangement is switched to different signal point arrangement at timing associated with timing at which a magnitude relationship between the temperature and a predetermined threshold value is changed during the predetermined period.

### (Supplementary Note 19)

The modulation control method according to supplementary note 18, further including, by the computer, setting the signal point arrangement used for modulation of the transmission signal to first signal point arrangement in a first section of the predetermined period, the first section being associated with a period during which the temperature is higher than the predetermined threshold value, and setting the signal point arrangement used for modulation of the transmission signal to second signal point arrangement in a second section of the predetermined period, the second section being associated with a period during which the temperature is equal to or lower than the predetermined threshold value,
wherein, as compared to the first signal point arrangement, the second signal point arrangement is signal point arrangement in which signal points are arranged in such a way that an interval between signal points is wider as intensity of the transmission signal is higher.

### (Supplementary Note 20)

The modulation control method according to any one of supplementary notes 17 to 19, further including,
by the computer:
   predicting a change of a non-linear characteristic of an amplifier during the predetermined period, based on data relating to a temperature during the predetermined period; and
   setting the signal point arrangement used for modulation of the transmission signal in such a way that the signal point arrangement used for modulation of the transmission signal is switched to different signal point arrangement during the predetermined period, based on the change of the non-linear characteristic.

### (Supplementary Note 21)

The modulation control method according to any one of supplementary notes 17 to 20, further including, by the computer, deciding whether to execute at least any of non-linear compensation or multiplexing based on the signal point arrangement being set, by using first power being required at a time of executing control of the signal point arrangement being set and non-linear compensation according to the signal point arrangement being set, second power being required for executing multiplexing with respect to the transmission signal, and usable power.

### (Supplementary Note 22)

The modulation control method according to supplementary note 21, further including, by the computer, when the first power is equal to or lower than the usable power, third power acquired by adding the second power to the first power is higher than the usable power, and fifth power acquired by subtracting fourth power from the third power is higher than the usable power, the fourth power being required for at least part of processing of non-linear compensation processing executed with respect to the transmission signal, deciding to execute non-linear compensation based on the signal point arrangement being set and not to execute the multiplexing.

### (Supplementary Note 23)

The modulation control method according to supplementary note 21 or 22, further including, by the computer, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal satisfies a predetermined condition, deciding to execute non-linear compensation and the multiplexing based on the signal point arrangement being set in a state in which the at least part of processing is not executed.

### (Supplementary Note 24)

The modulation control method according to any one of supplementary notes 21 to 23, further including, by the computer, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal does not satisfy a predetermined condition, changing the predetermined condition, changing the usable power in such a way as to satisfy the predetermined condition being changed, and further deciding whether to execute at least any of non-linear compensation or multiplexing based on the signal point arrangement being set by using the first power, the second power, and the usable power being changed.

### (Supplementary Note 25)

A program causing a computer to execute:
acquiring data relating to a temperature during a predetermined period; and
setting signal point arrangement used for modulation of a transmission signal in such a way that the signal point arrangement used for modulation of the transmission signal is switched to different signal point arrangement during the predetermined period, based on the data relating to the temperature.

### (Supplementary Note 26)

The program according to supplementary note 25, further causing the computer to execute setting the signal point arrangement used for modulation of the transmission signal in such a way that the signal point arrangement is switched to different signal point arrangement at timing associated with timing at which a magnitude relationship between the temperature and a predetermined threshold value is changed during the predetermined period.

### (Supplementary Note 27)

The program according to supplementary note 26, further causing the computer to execute setting the signal point arrangement used for modulation of the transmission signal to first signal point arrangement in a first section of the predetermined period, the first section being associated with a period during which the temperature is higher than the predetermined threshold value, and setting the signal point arrangement used for modulation of the transmission signal to second signal point arrangement in a second section of the predetermined period, the second section being associated with a period during which the temperature is equal to or lower than the predetermined threshold value, wherein, as compared to the first signal point arrangement, the second signal point arrangement is signal point arrangement in which signal points are arranged in such a way that an interval between signal points is wider as intensity of the transmission signal is higher.

### (Supplementary Note 28)

The program according to any one of supplementary notes 25 to 27, further causing the computer to execute:
predicting a change of a non-linear characteristic of an amplifier during the predetermined period, based on data relating to a temperature during the predetermined period; and
setting the signal point arrangement used for modulation of the transmission signal in such a way that the signal point arrangement used for modulation of the transmission signal is switched to different signal point arrangement during the predetermined period, based on the change of the non-linear characteristic.

### (Supplementary Note 29)

The program according to any one of supplementary notes 25 to 28, further causing the computer to execute deciding whether to execute at least any of non-linear compensation or multiplexing based on the signal point arrangement being set, by using first power being required at a time of executing control of the signal point arrangement being set and non-linear compensation according to the signal point arrangement being set, second power being required for executing multiplexing with respect to the transmission signal, and usable power.

### (Supplementary Note 30)

The program according to supplementary note 29, further causing the computer to execute, when the first power is equal to or lower than the usable power, third power acquired by adding the second power to the first power is higher than the usable power, and fifth power acquired by subtracting fourth power from the third power is higher than the usable power, the fourth power being required for at least part of processing of non-linear compensation processing executed with respect to the transmission signal, deciding to execute non-linear compensation based on the signal point arrangement being set and not to execute the multiplexing.

### (Supplementary Note 31)

The program according to supplementary note 29 or 30, further causing the computer to execute, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal satisfies a predetermined condition, deciding to execute non-linear compensation and the multiplexing based on the signal point arrangement being set in a state in which the at least part of processing is not executed.

### (Supplementary Note 32)

The program according to any one of supplementary notes 29 to 31, further causing the computer to execute, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal does not satisfy a predetermined condition, changing the predetermined condition, changing the usable power in such a way as to satisfy the predetermined condition being changed, and further deciding whether to execute at least any of non-linear compensation or multiplexing based on the signal point arrangement being set by using the first power, the second power, and the usable power being changed.

An example advantage according to the present disclosure is to enable to provide a modulation control apparatus, a modulation control method, and a program that are capable of suppressing a bit error of a transmission signal even when a temperature is changed.

What is claimed is:

1. A modulation control apparatus comprising:
at least one memory configured to store an instruction; and
at least one processor configured to execute the instruction, wherein
the processor, by executing the instruction,
acquires data relating to a temperature during a predetermined period, and
sets signal point arrangement used for modulation of a transmission signal in such a way that the signal point arrangement used for modulation of the transmission signal is switched to different signal point arrangement during the predetermined period, based on the data relating to the temperature.

2. The modulation control apparatus according to claim 1, wherein the at least one processor, by executing the instruction, further sets signal point arrangement used for modulation of the transmission signal in such a way that the signal point arrangement is switched to different signal point arrangement at timing associated with timing at which a magnitude relationship between the temperature and a predetermined threshold value is changed during the predetermined period.

3. The modulation control apparatus according to claim 2, wherein
the at least one processor, by executing the instruction, further sets signal point arrangement used for modulation of the transmission signal to first signal point arrangement in a first section of the predetermined period, the first section being associated with a period during which the temperature is higher than the predetermined threshold value, and sets signal point arrangement used for modulation of the transmission signal to second signal point arrangement in a second section of the predetermined period, the second section being associated with a period during which the temperature is equal to or lower than the predetermined threshold value, and,
as compared to the first signal point arrangement, the second signal point arrangement is signal point arrangement in which signal points are arranged in such a way that an interval between signal points is wider as intensity of the transmission signal is higher.

4. The modulation control apparatus according to claim 1, wherein
the at least one processor, by executing the instruction, further
predicts a change of a non-linear characteristic of an amplifier during the predetermined period, based on data relating to a temperature during the predetermined period, and
sets signal point arrangement used for modulation of the transmission signal in such a way that the signal point arrangement used for modulation of the transmission signal is switched to different signal point arrangement during the predetermined period, based on the change of the non-linear characteristic.

5. The modulation control apparatus according to claim 1, wherein the at least one processor, by executing the instruction, further decides whether to execute at least any of non-linear compensation or multiplexing based on the signal point arrangement being set, by using first power being required at a time of executing control of the signal point arrangement being set and non-linear compensation according to the signal point arrangement being set, second power being required for executing multiplexing with respect to the transmission signal, and usable power.

6. The modulation control apparatus according to claim 5, wherein the at least one processor, by executing the instruction, when the first power is equal to or lower than the usable power, third power acquired by adding the second power to the first power is higher than the usable power, and fifth power acquired by subtracting fourth power from the third power is higher than the usable power, the fourth power being required for at least part of processing of non-linear compensation processing executed with respect to the transmission signal, further decides to execute non-linear compensation based on the signal point arrangement being set and not to execute the multiplexing.

7. The modulation control apparatus according to claim 5, wherein the at least one processor, by executing the instruction, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal satisfies a predetermined condition, further decides to execute non-linear compensation and the multiplexing based on the signal point arrangement being set in a state in which the at least part of processing is not executed.

8. The modulation control apparatus according to claim 5, wherein the at least one processor, by executing the instruction, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal does not satisfy a predetermined condition, further changes the predetermined condition, changes the usable power in such a way as to satisfy the predetermined condition being changed, and further decides whether to execute at least any of non-linear compensation or multiplexing based on the signal point arrangement being set by using the first power, the second power, and the usable power being changed.

9. A modulation control method comprising,
by a computer:
acquiring data relating to a temperature during a predetermined period; and
setting signal point arrangement used for modulation of a transmission signal in such a way that the signal point arrangement used for modulation of the transmission signal is switched to different signal point arrangement during the predetermined period, based on the data relating to the temperature.

10. The modulation control method according to claim 9, further comprising, by the computer, setting the signal point arrangement used for modulation of the transmission signal in such a way that the signal point arrangement is switched to different signal point arrangement at timing associated with timing at which a magnitude relationship between the temperature and a predetermined threshold value is changed during the predetermined period.

11. The modulation control method according to claim 10, further comprising, by the computer, setting the signal point arrangement used for modulation of the transmission signal to first signal point arrangement in a first section of the predetermined period, the first section being associated with a period during which the temperature is higher than the predetermined threshold value, and setting the signal point arrangement used for modulation of the transmission signal to second signal point arrangement in a second section of the predetermined period, the second section being associated with a period during which the temperature is equal to or lower than the predetermined threshold value,
wherein, as compared to the first signal point arrangement, the second signal point arrangement is signal point arrangement in which signal points are arranged in such a way that an interval between signal points is wider as intensity of the transmission signal is higher.

12. The modulation control method according to claim 9, further comprising,
by the computer:
predicting a change of a non-linear characteristic of an amplifier during the predetermined period, based on data relating to a temperature during the predetermined period; and
setting the signal point arrangement used for modulation of the transmission signal in such a way that the signal point arrangement used for modulation of the transmission signal is switched to different signal point arrangement during the predetermined period, based on the change of the non-linear characteristic.

13. The modulation control method according to claim 9, further comprising, by the computer, deciding whether to execute at least any of non-linear compensation or multiplexing based on the signal point arrangement being set, by using first power being required at a time of executing control of the signal point arrangement being set and non-linear compensation according to the signal point arrangement being set, second power being required for executing multiplexing with respect to the transmission signal, and usable power.

14. The modulation control method according to claim 13, further comprising, by the computer, when the first power is equal to or lower than the usable power, third power acquired by adding the second power to the first power is higher than the usable power, and fifth power acquired by subtracting fourth power from the third power is higher than the usable power, the fourth power being required for at least part of processing of non-linear compensation processing executed with respect to the transmission signal, deciding to execute non-linear compensation based on the signal point arrangement being set and not to execute the multiplexing.

15. The modulation control method according to claim 13, further comprising, by the computer, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal satisfies a predetermined condition, deciding to execute non-linear compensation and the multiplexing based on the signal point arrangement being set in a state in which the at least part of processing is not executed.

16. The modulation control method according to claim 13, further comprising, by the computer, when the first power is equal to or lower than the usable power, third power acquired by adding the second power to the first power is higher than the usable power, fifth power acquired by subtracting fourth power from the third power is equal to or lower than the usable power, the fourth power being required for at least part of processing of non-linear compensation processing executed with respect to the transmission signal, and a parameter indicating accuracy of the transmission signal when the at least part of processing is not executed with respect to the transmission signal does not satisfy a predetermined condition, changing the predetermined condition, changing the usable power in such a way as to satisfy the predetermined condition being changed, and further deciding whether to execute at least any of non-linear compensation or multiplexing based on the signal point arrangement being set by using the first power, the second power, and the usable power being changed.

17. A non-transitory computer readable medium storing a program causing a computer to execute:
acquiring data relating to a temperature during a predetermined period; and
setting signal point arrangement used for modulation of a transmission signal in such a way that the signal point arrangement used for modulation of the transmission signal is switched to different signal point arrangement during the predetermined period, based on the data relating to the temperature.

18. The non-transitory computer readable medium according to claim 17, the program further causing the computer to execute setting the signal point arrangement used for modulation of the transmission signal in such a way that the signal point arrangement is switched to different signal point arrangement at timing associated with timing at which a magnitude relationship between the temperature and a predetermined threshold value is changed during the predetermined period.

19. The non-transitory computer readable medium according to claim 18, the program further causing the computer to execute setting the signal point arrangement used for modulation of the transmission signal to first signal point arrangement in a first section of the predetermined period, the first section being associated with a period during which the temperature is higher than the predetermined threshold value, and setting the signal point arrangement used for modulation of the transmission signal to second signal point arrangement in a second section of the predetermined period, the second section being associated with a period during which the temperature is equal to or lower than the predetermined threshold value,
wherein, as compared to the first signal point arrangement, the second signal point arrangement is signal point arrangement in which signal points are arranged in such a way that an interval between signal points is wider as intensity of the transmission signal is higher.

20. The non-transitory computer readable medium according to claim 17, further causing the computer to execute:
predicting a change of a non-linear characteristic of an amplifier during the predetermined period, based on data relating to a temperature during the predetermined period; and
setting the signal point arrangement used for modulation of the transmission signal in such a way that the signal point arrangement used for modulation of the transmission signal is switched to different signal point arrangement during the predetermined period, based on the change of the non-linear characteristic.
